(19) United States
(12) Patent Application Publication
(10) Pub. No.: US 2010/0244313 A1
(43) Pub. Date: Sep. 30, 2010

(54) Method for Handling a Liquid

(75) Inventors: Ulrich Eberth, Donauwoerth (DE); Martin Friedrich, Harsum (DE)

Correspondence Address: LERNER, DAVID, LITTENBERG,;KRUMHOLZ & MENTLIK, 600 SOUTH AVENUE WEST, WESTFIELD, NJ, 07090, US

(73) Assignees: AIRBUS DEUTSCHLAND GMBH, Hamburg (DE); Deutsches Zentrum fur Luft - und Raumfahrt e. V. (DLR), Koln (DE)

(21) Appl. No.: 12/084,725

(22) PCT Filed: Nov. 7, 2006
(86) PCT No.: PCT/EP2006/010659

§ 371 Date: May 6, 2009

(30) Foreign Application Priority Data
Nov. 10, 2005 (DE) 10 2005 053 695.6

(51) Int. Cl. B29C 71/02; B67D 7/80

(52) U.S. Cl. 264/237; 222/146.6

(57) ABSTRACT

A method for handling a liquid, in particular for the metered transfer of a liquid that is viscous at room temperature from a reservoir to a receiving container for the purpose of further processing the viscous liquid. In the method the receiving container is filled with the liquid. In this arrangement the liquid is present in a plurality of individual portions. Furthermore, the liquid is cooled such that the individual portions are present in a predominantly solid state of aggregation. Preferably, the individual portions are sufficiently small so that the transferred liquid is a frozen granulate.

This application claims the benefit of the filing date of German Patent Application. No. 10 2005 053 695.6 filed Nov. 10, 2005, the disclosure of which is hereby incorporated herein by reference.

### FIELD OF THE INVENTION

The invention relates to a method for handling a liquid, in particular for the metered transfer of a liquid that is viscous at room temperature from a reservoir to a receiving container for the purpose of further processing the viscous liquid.

### TECHNOLOGICAL BACKGROUND

In the so-called Resin Transfer Moulding (RTM) method a dry semi-finished fibrous product that is comprised of cut-to-size reinforcement fibres is placed into a two-part tool that comprises a top shell and a bottom shell. The tool is then closed and sealed. Subsequently, by way of a first feed line, an external reservoir filled with resin is coupled to the tool. Furthermore, by way of a second feed line a vacuum pump is pneumatically coupled to the tool. When a vacuum is applied, resin is then transferred from the external reservoir to the tool by way of the first feed line. In this way resin impregnates the semi-finished fibrous product. As an option, compressed air can also be applied to the reservoir so that the resin contained therein is additionally pushed into the tool.

By applying heat, which is fed by way of suitable heating elements to the tool and thus to the resin-impregnated component, the resin is cured so that the individual fibres of the component are connected to each other. After completion of curing, the composite component produced is removed from the tool. After cleaning the top shell and the bottom shell of the tool is available again for the production of new components.

The implementation of this method is associated with a problem in that when the reservoir is filled, the transferred quantity of resin can only be metered out very inaccurately. This is because the resin is usually a very viscous liquid that draws strings during the filling procedure. Typically, these strings do not always break off immediately as soon as the desired quantity of resin has been transferred to the reservoir.

There is a further problem in filling the reservoir in that, in addition, the resin material is a very sticky substance so that filling of the reservoir usually leads to considerable spillage outside said reservoir.

### SUMMARY OF THE INVENTION

There may be a need to provide a method for handling a liquid, which method makes possible precise and clean metering out of a quantity of liquid to be transferred to a reservoir, even in the case of a viscous liquid.

This need may be met by a method for handling a liquid, in particular for the metered transfer of a liquid that is viscous at room temperature, from a reservoir to a receiving container for the purpose of further processing the viscous liquid. The method comprising: filling the receiving container with a liquid, wherein the liquid is present in a plurality of individual portions, and wherein the liquid is cooled in such a way that the individual portions are present in a predominantly solid state of aggregation.

The above-mentioned method may be based on the recognition that in principle any liquid freezes when cooled to the required low temperature, thus assuming a solid state of aggregation. The required freezing temperature depends on the type of liquid to be transferred. The term “freezing” as used in the context of this application comprises any desired type of transition of a substance from a liquid to a solid state of aggregation. It should be pointed out that in particular in the case of viscous substances, for example in the case of thermoplastic materials, the transition from the liquid to the solid state of aggregation is often also referred to as “solidification”.

When compared to the transfer of viscous liquids by simple pouring, the use of frozen individual portions may avoid any formation of strings of liquid. Consequently, quantities of even extremely highly viscous liquids may be metered out very accurately. Furthermore, the transfer of frozen liquid may also be carried out in a simple manner without the need for attending to spillages on the outer region of the receiving containers.

Furthermore, with the method described, metering accuracy that has hitherto been impossible to achieve may be achieved in the case of particularly viscous liquids. Such particularly highly viscous liquids have hitherto required heating in order to reduce the viscosity of the liquid, before inaccurate metering may be made possible at all. However, since in a transfer procedure the temperature may never be set so as to be absolutely accurate and also constant, fluctuations in the viscosity during the transfer process cannot be avoided. This may result in conventional transfer processes always being associated with some inaccuracy in metering, due to fluctuations in the temperature. In contrast to this, the metering accuracy of the method presently described may be advantageously independent of the temperature because the transfer does not involve a viscous liquid but rather a bulk material made of solid individual fragments. Temperature fluctuations therefore may have either no influence or only an insignificant influence on the metering accuracy.

Depending on the application, the frozen liquid that has been transferred to the receiving container may be further processed either in the frozen state or said frozen liquid may first be heated up and may thus assume its liquid or viscous state. The RTM method described in the introduction to the description is one example of further processing of a viscous liquid.

It should expressly be pointed out that the described method for handling a liquid is in no way limited to the use in an RTM method. Apart from with the use of resin, the method may advantageously also be implemented with other viscous liquids. Examples, which are not to be interpreted as being limiting in any way, involve the metered-out transfer of an adhesive material in the production of adhesive parts, or the precisely metered-out transfer of viscous solder paste in the production of electronic modules. Furthermore, it should be noted that the term “liquid” in this application may in particular refer to a material that is liquid at room temperature, while the term “frozen liquid” or “solid liquid” may in particular refer to the same material at a temperature range in which the material is solid. In particular, in this application the term liquid may refer to a viscous liquid, i.e. to a material which, at room temperatures, is liquid but exhibit a relatively high viscosity. The term “runny liquid” may in particular refer to the state in which the material is runny, in particular at higher temperatures at which the material exhibit low viscosity.

According to an exemplary embodiment of the present invention, filling of the receiving container takes place with a liquid that is present in the form of frozen granulate. Since the granulate usually comprises a plurality of small individual portions of frozen liquid, particularly accurate metering-out of the overall quantity of liquid to be transferred may be achieved. In this context it should be emphasised that the described method for handling a liquid involves a transfer method in which the liquid is not continuously transferred, but instead is transferred in discrete portions, to the receiving container. Consequently, the metering accuracy may be all the greater the smaller the granules or pellets of the frozen liquid.

According to a further exemplary embodiment of the present invention, filling the receiving container takes place by a metering device that is equipped such that a precisely defined quantity of frozen liquid is transferred to the receiving container. In this arrangement, metering may, for example, take place by registering the number of transferred individual portions so that when the sizes or volumes of the individual portions are precisely known, the filling quantity may thus be determined exactly. Likewise, if the average size of the individual portions is precisely known, exact metering-out may take place provided that a plurality of individual portions are transferred, and that larger and smaller individual portions average each other out. Likewise, precise metering-out may take place if, in the case of a comparatively small size of the individual portions, a particular time passes, during which according to the principle of an egg timer a multitude of small individual portions leave the metering device.

According to a further exemplary embodiment of the present invention, filling the receiving container takes place in a cold environment. By such a measure, condensation of atmospheric humidity on the cold individual portions may largely be prevented. In this way, any undesired transfer of water to the receiving container may be avoided.

According to a further exemplary embodiment of the present invention, filling the receiving container takes place in a dry environment. This measure may also make it possible to prevent undesired condensation of atmospheric humidity on the cold individual portions. A dry environment may be realised both by dried air and by other gases, for example nitrogen, that are present in the space where filling takes place. In this arrangement the transfer process may, for example, take place in a chamber so that the region of liquid transfer is separated from an external environment. However, the liquid transfer may also be open towards the outside, wherein in this case it must be ensured that, by way of a corresponding stream, dry air or dry gas reaches the region of the liquid transfer and the receiving container.

According to a further exemplary embodiment of the present invention, an additional step is provided in which an above-mentioned metering device is filled with a gas that is heavier than air. Filling the reservoir with the heavy gas may prevent condensation of atmospheric humidity on the cold individual portions already prior to transfer to the receiving container. The gas therefore may act as a protective gas which may reliably prevent condensation of atmospheric humidity. Provided the metering device is located above the receiving container during the filling procedure, the heavy gas may flow out automatically together with the frozen individual portions and may reach the receiving container, as do the frozen individual portions. Thus the individual portions may be protected against condensation moisture not only in the metering device but also during filling as well as in the receiving container.

According to a further exemplary embodiment of the present invention, a further step is provided, in which the plurality of individual portions of frozen liquid are produced. In this context it is unimportant whether the liquid is first cooled and singling out of the frozen liquid granules takes place only thereafter, or whether the liquid is first divided into small individual portions, and the individual portions are cooled only after this. Likewise, both cooling and singling out may take place in a common step.

According to a further exemplary embodiment of the present invention, producing the plurality of individual portions of frozen liquid first takes place by filling a runny liquid into individual moulds, followed by cooling the portions of liquid filled into the individual moulds. This type of producing frozen and singled-out portions of liquid resembles a method for producing ice cubes which, for example, are used for the rapid cooling of drinks.

According to a further exemplary embodiment of the present invention, producing the plurality of individual portions of frozen liquid first takes place by cooling a specified quantity of liquid. Cooling continues until a frozen material is present. This is followed by mechanical singling-out of the frozen material until the individual portions are present in a predetermined size. This type of production of individual portions of frozen liquid is comparable to mechanical shredding. It is pointed out that in a mechanical shredding process it may be frequently the case that individual fragments of different sizes are produced. In this case the feature according to which the individual portions are present at a predefined size should be interpreted in the sense of the individual portions having a predefined average size.

According to a further exemplary embodiment of the present invention, producing the plurality of individual portions of frozen liquid first takes place by spraying the liquid so that a plurality of small droplets of liquid arise. Thereafter the small droplets of liquid are cooled off so that these droplets of liquid solidify. By spraying the liquid into a cold atmosphere the liquid may be transformed to particularly small or fine individual portions. In this way particularly good metering-out accuracy may be achieved.

It should be pointed out that particularly small droplets of liquid and thus particularly small portions of frozen liquid may be produced in that the liquid to be sprayed is warmed up prior to the spraying procedure so that the viscosity of said liquid may be reduced. As a result of the particularly small individual portions of frozen droplets of liquid the dosing accuracy may be further enhanced.

### BRIEF DESCRIPTION OF THE FIGURES

Further advantages and features of the present invention result from the following exemplary description of presently preferred exemplary embodiments. The drawing diagrammatically shows the following:

FIG. 1 filling of a receiving container with a frozen liquid granulate that is contained in a metering device;

FIG. 2 filling of a receiving container with a frozen liquid granulate in a cold atmosphere;

FIG. 3 filling of a receiving container with a frozen liquid granulate in a dry atmosphere;

FIG. 4 filling of a receiving container with a frozen liquid granulate that is surrounded by a protective gas;

FIG. 5 filling of a runny liquid into small individual moulds for the purpose of subsequently producing individual portions of frozen liquid;

FIG. 6 mechanically singling out a frozen material of frozen liquid for the purpose of producing a granulate made of a frozen liquid; and

FIG. 7 spraying a runny liquid into a cold atmosphere for the purpose of producing a fine granulate made of a frozen liquid.

### DETAILED DESCRIPTION OF EXEMPLARY EMBODIMENTS

It should be noted that in the drawings reference signs of same or corresponding components only differ by their first digit.

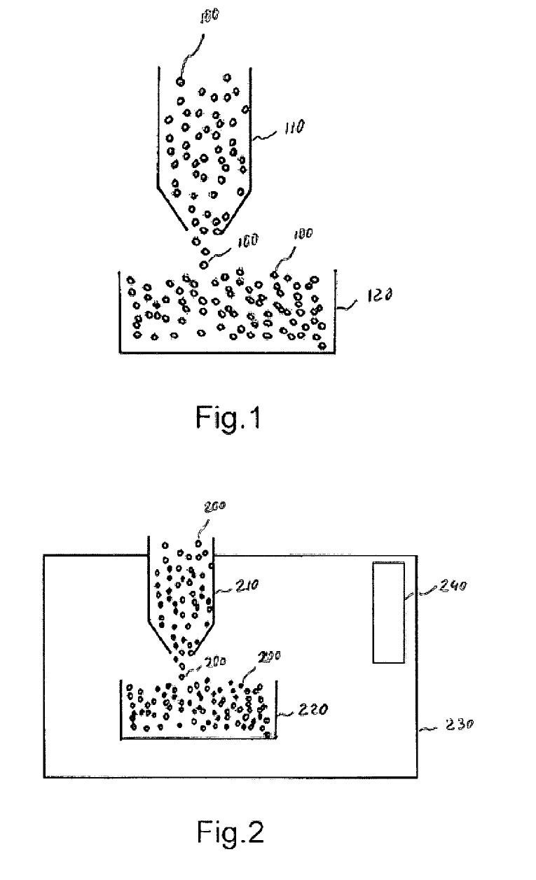

FIG. 1 diagrammatically shows the filling of a receiving container 120 with a liquid that is viscous at room temperature. The liquid is present in the form of a frozen granulate 100 so that when the receiving container 120 is filled, no strings of liquid form. In order to achieve precise metering-out of the granulate transferred to the receiving container 120, a metering device 110 is provided. On the one hand the metering device 110 makes it possible to precisely dose the quantity of granulate to be transferred, and on the other hand to neatly fill the receiving container 120 with the liquid that is viscous at room temperature. Filling the receiving container 120 thus represents a discrete transfer of a plurality of small individual portions of frozen liquid. Since in this process no strings of liquid are produced, it is thus possible in a simple manner to prevent undesired spillage into the surroundings of the receiving container 120.

FIG. 2 shows an advantageous embodiment variant of the filling of a receiving container 220 with a frozen liquid-granulate 200. Filling takes place for the purpose of accurate metering by a metering device 210. Unlike to the embodiment shown in FIG. 1, filling takes place in a transfer chamber 230 that comprises a boundary wall. The boundary wall preferably has a thermally insulating effect so that within the chamber 230 by a refrigerating set 240 a low temperature can be generated and also held. Filling the receiving container 220 in a cold atmosphere provides an advantage in that during the filling process no atmospheric humidity is deposited on the frozen granules 200. In this way a situation can be prevented where in addition to the desired transfer of the frozen liquid, water in the form of condensate that has deposited on the frozen granules 200 is transferred to the receiving container 220.

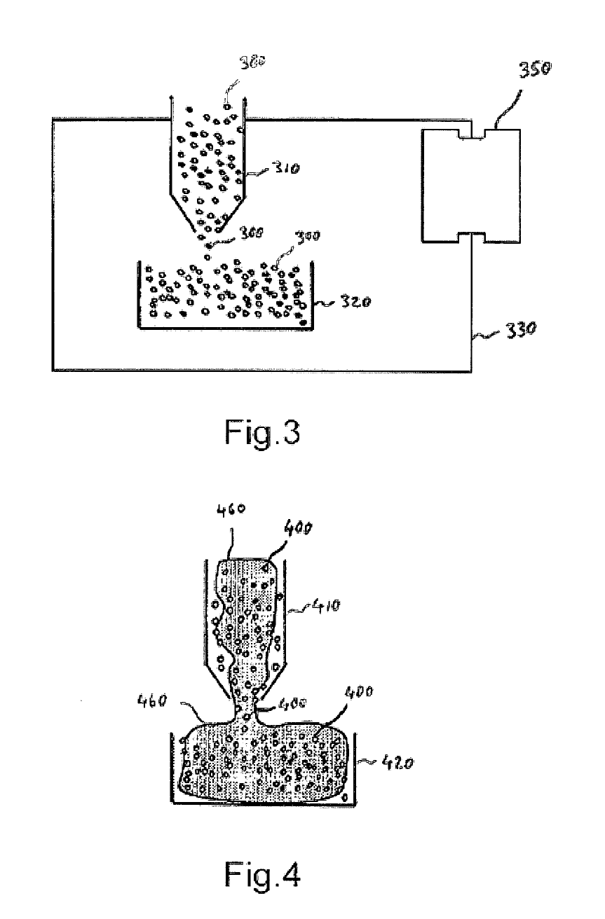

FIG. 3 shows a further advantageous embodiment variant of filling a receiving container 320 with a frozen liquid-granulate 300. As is the case in the previously described exemplary embodiments, in this embodiment, too, filling takes place by using a metering device 310. Unlike as the process of filling in a cold atmosphere, as shown in FIG. 2, according to the exemplary embodiment presently described filling takes place in a dry atmosphere so that, likewise, depositing of condensation moisture on the frozen granules 300 is prevented. The dry atmosphere is generated in a transfer chamber 330 that comprises a largely gas-proof boundary wall. Generating the dry atmosphere takes place by using an air dehumidifier 350 that collects the atmospheric humidity present in the transfer chamber 330 and conveys it to the external environment of the transfer chamber 330. It should be pointed out that instead of containing dry air, the transfer chamber 330 can also comprise some other gas, for example nitrogen.

FIG. 4 shows a further advantageous embodiment variant of filling a receiving container 420 with a frozen liquid-granulate 400. According to the exemplary embodiment described in FIG. 4, condensation of atmospheric humidity on the frozen granules 400 is prevented by the use of a protective gas 460 that is introduced into a metering device 410 already prior to the actual filling of the receiving container 420. The protective gas 460 is heavier than air. Thus during filling of the receiving container 420, which is arranged immediately below the metering device 410, said protective gas 460 automatically flows into the receiving container 420. This ensures that the frozen granules 400 are always surrounded by the protective gas 460. The protective gas can thus also prevent any depositing of condensation moisture on the granules 400. According to the exemplary embodiment presently described, this protection is not only ensured during filling. Protection against condensation moisture also exists in the metering device 410 and in the receiving container 420.

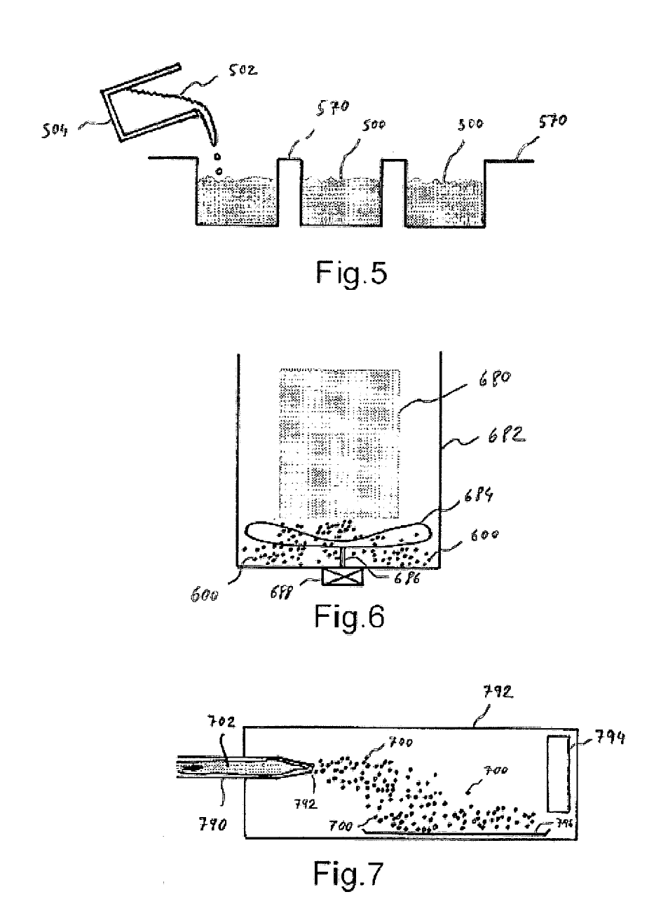

Below, with reference to FIGS. 5, 6 and 7, three options are described of positioning a liquid that is viscous at room temperature, for the purpose of simple handling of the liquid, such that a plurality of frozen individual portions of frozen liquid are present.

As shown in FIG. 5, individual portions of frozen liquid 500 can be produced in that a liquid 502 which at first is still liquid is poured from a reservoir 504 into a mould 570 that comprises a plurality of indentations or recesses for the purpose of accommodating a predefined quantity of liquid 502. After the mould 570 has been filled, said mould 570 together with the liquid contained therein is cooled in such a way that the liquid freezes. In this way many individual portions of frozen liquid 500 are produced. The manner of producing the frozen individual portions is similar to the universally known production of ordinary ice cubes, which are, for example, provided for the cooling of drinks.

As shown in FIG. 6, a granulate 600 of frozen liquid can also be produced by using a mechanical singling-out process. This type of granulate production corresponds to known shredding. In this arrangement a substantial quantity of frozen liquid 680 that is present as one piece of frozen material is placed into a shredder container 682. In the shredder container 682 a grinding gear 684, which is driven by a motor 688 by way of a drive shaft 686, ensures gradual singling-out of the frozen liquid 680. In this way the frozen granulate 600 arises, wherein the average size of the individual granules 600 among other things depends on the geometry of the grinding gear 684, on the rotational speed of the grinding gear 684, as well as in particular on the duration of the shredding process. In order to prevent heating up or undesired melting of the granules 600, the shredder container 682 can be arranged in a refrigerator so that during the entire shredding process a uniformly low temperature within the shredder container 682 is ensured.

As shown in FIG. 7, a granulate 700 comprising a frozen liquid can also be produced by spraying at first runny liquid 702 into a cold atmosphere. To this effect the liquid 702 is pushed at high pressure through a spray diffuser 790 or liquid spray diffuser. During exit through an outlet aperture 792 or through a plural number of small outlet apertures 792 the liquid in the form of small liquid-droplets 700 is sprayed into a freezing room 792. In the freezing room 792 there is a refrigerating set 794 that ensures a low temperature within the freezing room 792. Due to the low temperature within the freezing room 792 the liquid-droplets 700 are quickly cooled down so that they form a plurality of small frozen granules 700. The granules 700 are collected in a trough 796 in which they are held. When a certain quantity of granulate 700 has been produced, the trough 796 makes possible simple transfer of the granulate to a metering device that is shown in FIGS. 1 to 4.

It should be pointed out that particularly small droplets of liquid and thus a particularly fine granulate can be produced in that the liquid to be sprayed is warmed up prior to the spraying procedure so that the viscosity of said liquid is reduced. The increased temperature of the liquid-droplets does not negatively affect the freezing process. In the case of particularly small liquid-droplets the ratio of surface to volume of the liquid-droplet is particularly high so that, as a result of this, cooling of the heated-up and therefore small liquid-droplets takes place at least as quickly as does the cooling of non-heated but instead somewhat larger liquid-droplets.

In addition, it should be pointed out that “comprising” does not exclude other elements or steps, and “a” or “one” does not exclude a plural number. Furthermore, it should be pointed out that features or steps which have been described with reference to one of the above exemplary embodiments can also be used in combination with other features or steps of other exemplary embodiments described above. Reference signs in the claims are not to be interpreted as limitations.

### LIST OF REFERENCE SIGNS

100 Liquid (frozen and singled-out)/granulate
110 Metering device
120 Receiving container
200 Liquid (frozen and singled-out)/granulate
210 Metering device
220 Receiving container
230 Transfer chamber (thermally insulated)
240 Refrigerating set
300 Liquid (frozen and singled-out)/granulate
310 Metering device
320 Receiving container
330 Transfer chamber (gas-proof)
350 Air dehumidifier
400 Liquid (frozen and singled-out)/granulate
410 Metering device
420 Receiving container
460 Protective gas
500 Liquid (frozen and singled-out)/granulate
502 Liquid (viscous)
504 Reservoir
570 Mould
600 Liquid (frozen and singled-out)/granulate
680 Frozen liquid
682 Shredder container
684 Grinding gear
686 Drive shaft
688 Drive motor
700 Liquid (frozen and singled-out)/granulate
702 Liquid (viscous)
790 Spray diffuser
792 Outlet aperture
792 Freezing room
794 Refrigerating set

1. A method for handling a liquid, in particular for the metered transfer of a liquid that is viscous at room temperature from a reservoir to a receiving container for further processing the viscous liquid, the method comprising:
filling the receiving container with the liquid in a cold environment and/or in a dry environment;
wherein the liquid is present in a plurality of individual portions; and
wherein the liquid is cooled such that the individual portions are present in a predominantly solid state of aggregation.

2. The method of claim 1, wherein the liquid is present in the form of frozen granulate.

3. The method of claim 1, wherein
the filling of the receiving container is carried out by a metering device that transfers a precisely defined quantity of frozen liquid to the receiving container.

4. The method of claim 3, further comprising filling the metering device with a gas that is heavier than air.

5. The method of claim 1, further comprising:
producing the plurality of individual portions of frozen liquid.

6. The method of claim 5, wherein
the producing of the plurality of individual portions of frozen liquid comprises:
filling liquid into correspondingly designed individual moulds, and
cooling the portions of liquid filled into the individual moulds.

7. The method of claim 5, wherein
the producing of the plurality of individual portions of frozen liquid comprises:
cooling a predefined quantity of liquid until a frozen material arises, and
mechanically singling out the frozen material until the individual portions are present at a predefined size.

8. The method of claim 5, wherein
the producing of the plurality of individual portions of frozen liquid comprises:
spraying the liquid so that a plurality of small liquid-droplets arise, and
cooling and freezing the small liquid droplets.
